(19) United States
(12) Patent Application Publication
(10) Pub. No.: US 2018/0078464 A1
(43) Pub. Date: Mar. 22, 2018

(54) ILLUMINATED BABY BOTTLE DEVICE AND METHOD

(71) Applicant: VICTOR SANCHEZ, ROME, NY (US)

(72) Inventor: VICTOR SANCHEZ, ROME, NY (US)

(21) Appl. No.: 15/709,444

(22) Filed: Sep. 19, 2017

Related U.S. Application Data
(60) Provisional application No. 62/396,484, filed on Sep. 19, 2016.

(51) Int. Cl. A61J 17/00

(52) U.S. Cl. CPC A61J 17/005; A47G 2019/2238; A61J 17/002

(57) ABSTRACT

An illuminated baby bottle device including a cap, a nipple, a body configured to retain a liquid, and a base. The body includes an inner-wall and an outer-wall. The nipple is affixable and sealed to the cap, and the protective-cover is also affixable to the cap to protect the nipple and maintain sanitary conditions of the nipple, where the cap is affixable to one end of the body. The base is affixable to the body on the opposing end from the cap. Base is affixable to the body, with the base including a power-supply and an audio-source configured to provide an audio-track. The body includes a light-source arranged between the inner-wall and the outer-wall configured to illuminate the baby bottle device. The light-source includes multiple colors and is illuminated by at least one light-emitting-diode.

### CROSS-REFERENCE TO RELATED APPLICATION(S)

The present application is related to and claims priority to U.S. Provisional Patent Application No. 62/396,484 filed Sep. 19, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of illumination of existing art and more specifically relates to liquid containers with illumination.

### RELATED ART

A baby bottle is a non-spillable drinking vessel that includes a nipple for a child to drink directly from. It is typically used by infants and/or younger children, as they cannot generally drink directly from a cup without spilling the liquid contained within. Generally, a bottle is used to feed infant formula, expressed breast milk, juice, pediatric solutions, or other similar liquids.

Infants and small children may become bored or uninterested while drinking from a bottle at times, which may lead to the child resisting the bottle. Additionally, parents may enter the child's room in darkness to retrieve the bottle after the child has fallen asleep. In some cases, the bottle may be hard to locate in these darkened conditions. Therefore a suitable solution is desired.

U.S. Pat. Pub. No. 2009/0321458 to Holly E. Blair and Lisa A. Passarelli relates to a child drinking vessel. The described child drinking vessel includes a non-spillable vessel which including a detachable lid assembly with an anti-spill tip or a detachable spill stopper, a body with an interior for containing liquid, and a detachable base. The detachable base of the vessel is a sealed compartment containing LED lights and/or sound and associated circuitry.

### SUMMARY OF THE INVENTION

In view of the foregoing disadvantages inherent in the known liquid containers art, the present disclosure provides a novel illuminated baby bottle and method. The general purpose of the present disclosure, which will be described subsequently in greater detail, is to provide an illuminated baby bottle and method of use therefore.

An illuminated baby bottle device is disclosed herein, which may be referred to as “BRIGHT LIGHT BABA”. The illuminated baby bottle device preferably includes a cap, a nipple, a body configured to retain a liquid, and a base. The body includes an inner-wall and an outer-wall. The nipple is affixable and sealed to the cap, and the protective-cover is also affixable to the cap to protect the nipple and maintain sanitary conditions of the nipple, where the cap is affixable to one end of the body. Also, the base is affixable to the body on the opposing end from the cap, preferable by a threaded connection. The body is preferably shatter-proof.

Similarly, the base is affixable to the body, with the base including a power-supply and an audio-source configured to provide an audio-track; the audio-track including audible music. In a preferred embodiment, the power-supply is removable and replaceable, and additionally rechargeable.

Also, the body includes a light-source arranged between the inner-wall and the outer-wall configured to illuminate the baby bottle device, with the light source powered by the power-supply contained within the base. Preferably both the inner-wall and the outer-wall are translucent such that a parent of a child (user) may view the contents of the inner-wall while the outer-wall displays the illumination. The light-source includes multiple colors and is illuminated by at least one light-emitting-diode.

According to another embodiment, a method of using an illuminated baby bottle device is also disclosed herein. The method of using an illuminated baby bottle device includes a first step, providing an illuminated baby bottle device, the device including a cap, a nipple, a body, and a base; a second step, uploading an audio-track to the base; a third step, placing a liquid with the body; a fourth step, affixing the cap to said body; a fifth step, affixing the base to the body; a sixth step, illuminating the device; a seventh step, commencing playing the audio-track; an eight step, ceasing playing the audio-track; a ninth step, deluminating the device; a tenth step, removing the base from the body; and an eleventh step, recharging the base.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an illuminated baby bottle and method, constructed and operative according to the teachings of the present disclosure.

FIG. 1 is a perspective view of the illuminated baby bottle during an ‘in-use’ condition, according to an embodiment of the disclosure.

FIG. 2A is a top perspective view of the illuminated baby bottle of FIG. 1, according to an embodiment of the present disclosure.

FIG. 2B is a bottom perspective view of the illuminated baby bottle of FIG. 1, according to an embodiment of the present disclosure.

FIG. 3 is an exploded perspective view of the illuminated baby bottle of FIG. 1, according to an embodiment of the present disclosure.

FIG. 4 is a perspective view of the illuminated baby bottle of FIG. 1, according to an embodiment of the present disclosure.

FIG. 5 is a flow diagram illustrating a method of using an illuminated baby bottle, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a liquid container and more particularly to an illuminated baby bottle and method as used to improve the use of a baby bottle by including illumination and sound to increase interest of the child to the bottle as well as providing increased visibility of the bottle in low-light conditions.

Generally, an illuminated baby bottle device (“BRIGHT LIGHT BABA”) may entertain children before naptime or bedtime feedings. The device may include a child's bottle or cup which may illuminate and/or play an audio-track. The illumination is located between a translucent double-walled design. The bottom of the device may include a base which is detachable via threads or other suitable means. The base may include an audio player that includes speakers, a mechanism to control the illumination, a rechargeable battery, and memory storage for the audio player. The music may feature one or more songs that can be uploaded to the device via a universal-serial-bus, or the device may include the capability to sync with a mobile device.

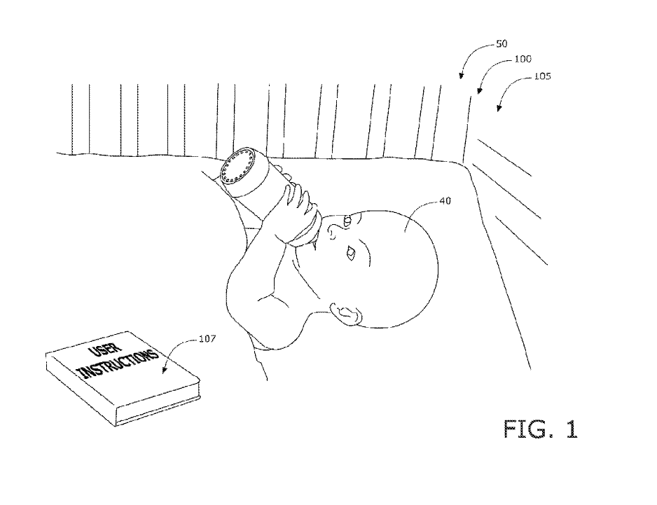

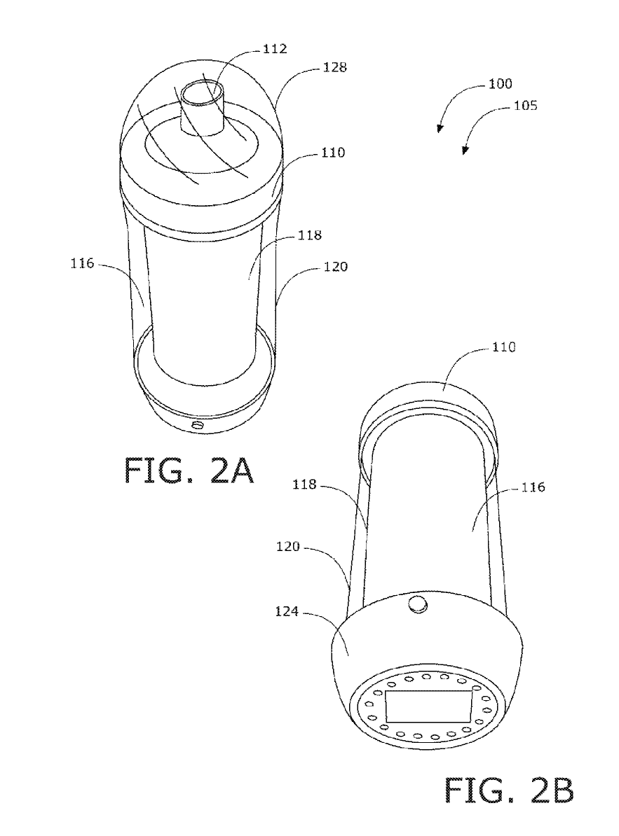

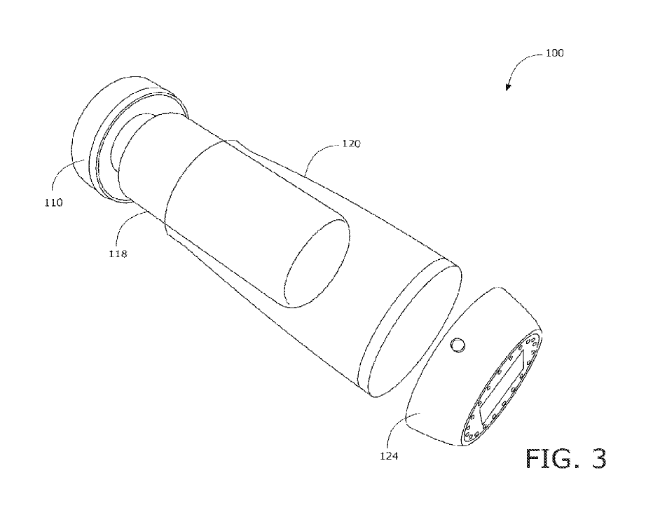

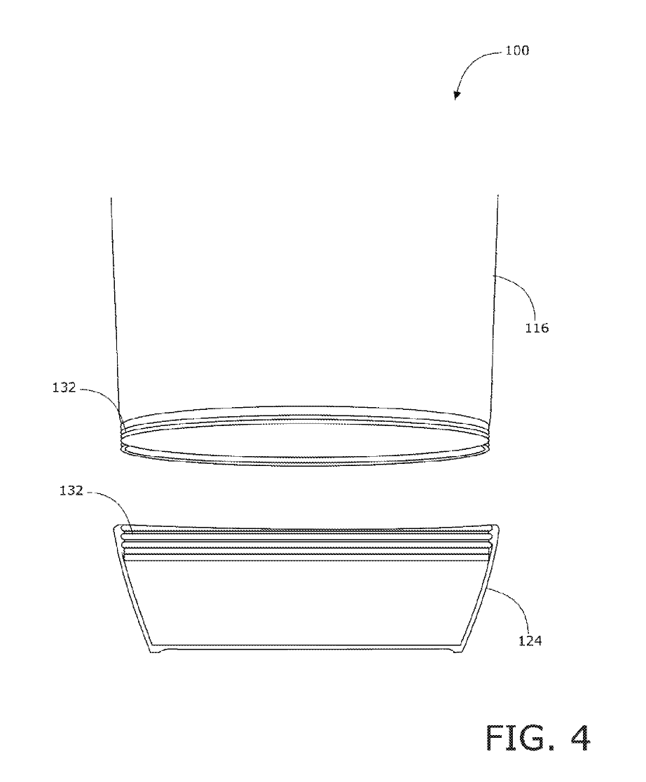

Referring now more specifically to the drawings by numerals of reference, there is shown in FIGS. 1-4, various views of an illuminated baby bottle 100.

FIG. 1 shows illuminated baby bottle 100 during an ‘in-use’ condition 50, according to an embodiment of the present disclosure. Here, illuminated baby bottle 100 may be beneficial for use by user 40 to illuminate a baby bottle to increase a child's interest in the bottle as well as making the bottle more easily locatable in dark or low-light conditions.

According to one embodiment, the illuminated baby bottle 100 may be arranged as a kit 105. In particular, the illuminated baby bottle 100 may further include a set of instructions 107. The instructions 107 may detail functional relationships in relation to the structure of the illuminated baby bottle 100 such that the illuminated baby bottle 100 can be used, maintained, or the like, in a preferred manner.

Referring now to FIGS. 1-4, as illustrated, illuminated baby bottle device 100 may include cap 110, nipple 112, body 116, and base 124, where nipple 112 is affixable to cap 110, cap 110 is affixable to body 116, and base 124 is affixable to body 116 on an end opposite cap 110. Base may include a power-supply. Body 116 may be configured to retain a liquid and may body 116 may include inner-wall 118 and outer-wall 120 where inner-wall 118 and outer-wall 120 may be translucent and body 116 may include a light-source arranged between inner-wall 118 and outer-wall 120 configured to illuminate baby bottle device 100 during use.

Embodiments may also include protective-cover 128 affixable to cap 110 to protect cap 110 and nipple 112and to prevent contamination of nipple 112. Base 124 may be removably affixable to body 116 via a threaded connection, in embodiments. Alternate embodiments may include other attachments between base 124 and body 116 (e.g., snap-fit, fasteners, etc.). Body 116, and other components of illuminated baby bottle device 100, may be constructed from ‘shatter-proof’ materials for improved safety and longevity during use.

Light-source may include one or more light-emitting-diodes or other similar lights. Also, light source may include a plurality of different colors that may illuminate individually and/or at the same time. Similar to audio-source, light-source may include a timer and/or be programmable to stop/start at predetermined times.

Additionally, illuminated baby bottle device 100 may include an audio-source configured to provide an audio-track to a user. Audio-source may provide music, audible voice recording, and/or other various sounds. Audio-source may further include a timer to automatically shut off after a predetermined time interval and/or audio-source may be programmable such that audio-source may stop and/or start at a predetermined time and/or interval. Audio-track may be uploadable to audio-source via a universal-serial-bus connection or other similar wired connection. Also, audio-track may be uploadable via a mobile application. Each of light-source and audio-source may include a soft on/off switch to initiate and terminate operations. Power-supply may be removable and replaceable in some embodiments. Embodiments may include power-supply which is rechargeable.

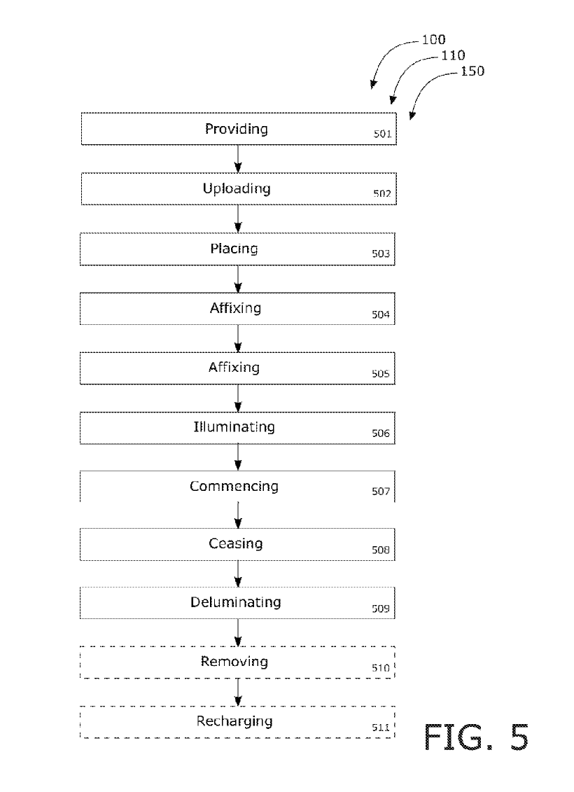

FIG. 5 is a flow diagram illustrating a method of using 500 an illuminated baby bottle 100, according to an embodiment of the present disclosure. In particular, the method of using 500 an illuminated baby bottle device 100 may include one or more components or features of the illuminated baby bottle device 100 as described above. As illustrated, the method for method of using 500 an illuminated baby bottle device 100 may include the steps of: step one, providing an illuminated baby bottle device 100; step two, uploading an audio-track to base 124; step three, placing a liquid with body 116; step four, affixing cap 110 to body 116; step five, affixing base 124 to body 116; step six, illuminating device 100; step seven, commencing playing an audio-track; step eight, ceasing playing the audio-track; step nine, deluminating device 100; step ten, removing base 124 from body 116; and step eleven, recharging base 124.

It should be noted that step ten 510 and step eleven 511 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of using an illuminated baby bottle are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An illuminated baby bottle device, said device comprising:
a cap,
a nipple, said nipple affixable to said cap;
a body configured to retain a liquid, said body including an inner-wall and an outer-wall; and
a base affixable to said body, said base including a power-supply;
wherein said cap is affixable to said body;
wherein said base is affixable to said body on an end opposite said cap;
wherein said inner-wall and said outer-wall are translucent; and
wherein said body includes a light-source arranged between said inner-wall and said outer-wall configured to illuminate said baby bottle device.

2. The device of claim 1, further comprising an audio-source configured to provide an audio-track.

3. The device of claim 2, wherein said audio-source provides audible music.

4. The device of claim 2, wherein said audio-source provides an audible voice recording.

5. The device of claim 2, wherein said audio-source includes a timer.

6. The device of claim 2, wherein said audio-source is programmable such that said audio-source begins and ends said audio-track at predetermined time.

7. The device of claim 2, wherein said audio-track is uploadable to said audio-source via a universal-serial-bus connection.

8. The device of claim 1, wherein said light source includes at least one light-emitting-diode.

9. The device of claim 1, wherein said light source includes multiple colors.

10. The device of claim 1, wherein said light source includes a timer.

11. The device of claim 1, wherein said light source is programmable such that said light-source illuminates and deluminates at predetermined times and intervals.

12. The device of claim 1, wherein said device further includes a protective-cover affixable to said cap.

13. The device of claim 1, wherein said base is affixable to said body via a threaded connection.

14. The device of claim 1, wherein said body is shatter-proof.

15. The device of claim 1, wherein said power-supply is removable and replaceable

16. The device of claim 1, wherein said power-supply is rechargeable.

17. An illuminated baby bottle device, said device comprising:
a cap,
a nipple, said nipple affixable to said cap;
a protective-cover affixable to said cap;
a body configured to retain a liquid, said body including an inner-wall and an outer-wall; and
a base affixable to said body, said base including a power-supply and an audio-source configured to provide an audio-track;
wherein said cap is removably affixable to said body;
wherein said base is affixable to said body on an end opposite said cap;
wherein said inner-wall and said outer-wall are translucent; and
wherein said body includes a light-source arranged between said inner-wall and said outer-wall configured to illuminate said baby bottle device;
wherein said audio-source provides audible music;
wherein said light source includes multiple colors;
wherein said light source includes at least one light-emitting-diode;
wherein said light source includes at least one light-emitting-diode;
wherein said base is affixable to said body via a threaded connection;
wherein said body is shatter-proof;
wherein said power-supply is removable and replaceable; and
wherein said power-supply is rechargeable.

18. The device of claim 17, further comprising set of instructions; and
wherein said device is arranged as a kit.

19. A method of using an illuminated baby bottle device, said method comprising the steps of:
providing an illuminated baby bottle device, said device including a cap, a nipple, a body, and a base;
uploading an audio-track to said base;
placing a liquid with said body;
affixing said cap to said body;
affixing said base to said body;
illuminating said device;
commencing playing said audio-track;
ceasing playing said audio-track; and
deluminating said device.

20. The method of claim 19, further comprising the steps of:
removing said base from said body; and
recharging said base.
